(19) United States
(12) Patent Application Publication
(10) Pub. No.: US 2004/0205184 A1
(43) Pub. Date: Oct. 14, 2004

(54) E-business operations measurements reporting

(75) Inventors: Stig Arne Olsson, Apex, NC (US); David Michael Urgo, Cary, NC (US); Geetha Vijayan, Austin, TX (US)

Correspondence Address: Paul D. Heydon, Patent Attorney, Suite 300, 909 N.E. Loop 410, San Antonio, TX, 78209, US

(73) Assignee: International Business Machines Corporation, Armonk, NY

(21) Appl. No.: 10/383,853

(22) Filed: Mar. 6, 2003

(51) Int. Cl. G06F 15/173

(52) U.S. Cl. 709/224

(57) ABSTRACT

An example of a solution provided here comprises: (a) collecting data from a production environment, utilizing a plurality of probes; (b) performing calculations, regarding availability or response time or both, with at least part of the data; (c) outputting statistics, resulting from the calculations; and (d) performing (a)-(c) above for a plurality of applications, whereby the applications may be compared. Another example comprises: receiving data for a plurality of transaction steps, from a plurality of probes; calculating statistics based on the data; mapping the statistics to at least one threshold value; and outputting a representation of the mapping.

### CROSS-REFERENCES TO RELATED APPLICATIONS, AND COPYRIGHT NOTICE

The present patent application is related to co-pending patent applications: Method and System for Probing in a Network Environment, application Ser. No. 10/062,329, filed on Jan. 31, 2002, Method and System for Performance Reporting in a Network Environment, application Ser. No. 10/062,369, filed on Jan. 31, 2002, End to End Component Mapping and Problem—Solving in a Network Environment, application Ser. No. 10/122,001, filed on Apr. 11, 2002, Graphics for End to End Component Mapping and Problem—Solving in a Network Environment, application Ser. No. 10/125,619, filed on Apr. 18, 2002, and E-Business Operations Measurements, application Ser. No. 10/256,094, filed on Sep. 26, 2002. These co-pending patent applications are assigned to the assignee of the present application, and herein incorporated by reference. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to information handling, and more particularly to methods and systems for evaluating the performance of information handling in a network environment.

### BACKGROUND OF THE INVENTION

Various approaches have been proposed for monitoring, simulating, or testing web sites. However, some of these approaches address substantially different problems (e.g. problems of simulation and hypothetical phenomena), and thus are significantly different from the present invention. Other examples include services available from vendors such as Atesto Technologies Inc., Keynote Systems, and Mercury Interactive Corporation. These services may involve a script that runs on a probe computer. The approaches mentioned above do not necessarily allow some useful comparisons.

It is very useful to measure the performance of applications such as web sites, web services, or other applications accessible to a number of users via a network. Concerning two or more such applications, it is very useful to compare numerical measures. Accurate evaluation or comparison may allow proactive management and reduce mean time to repair problems, for example. However, accurate evaluation or comparison may be hampered by inconsistent calculation and communication of measures. Inconsistent, variable, or heavily customized techniques are common. There are no generally—accepted techniques to be used on applications that have been deployed in a production environment. Inconsistent techniques for calculating and communicating measurements result in problems such as unreliable performance data, and increased costs for administration, training and creating reports. Thus there is a need for systems and methods that solve problems related to inconsistent calculation and communication of measurements.

### SUMMARY OF THE INVENTION

An example of a solution to problems mentioned above comprises: (a) collecting data from a production environment, utilizing a plurality of probes; (b) performing calculations, regarding availability or response time or both, with at least part of the data; (c) outputting statistics, resulting from the calculations; and (d) performing (a)-(c) above for a plurality of applications, whereby the applications may be compared.

Another example of a solution comprises receiving data for a plurality of transaction steps, from a plurality of probes; calculating statistics based on the data; mapping the statistics to at least one threshold value; and outputting a representation of the mapping.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 illustrates a simplified example of a computer system capable of performing the present invention.

FIG. 2 is a block diagram illustrating one example of how the present invention may be implemented for communicating measurements for one or more applications.

FIG. 3A and FIG. 3B illustrate an example of a report with data from remote probes, and statistics.

FIG. 4A and FIG. 4B illustrate an example of a report with data from a local probe, and statistics.

FIG. 5 illustrates an example of a report that gives an availability summary.

FIG. 6 is a block diagram illustrating one example of how measurements may be utilized in the development, deployment and management of an application.

FIG. 7 is a flow chart with a loop, illustrating an example of communicating measurements, according to the teachings of the present invention.

FIG. 8 is a flow chart illustrating another example of calculating and communicating measurements, according to the teachings of the present invention.

### DETAILED DESCRIPTION

The examples that follow involve the use of one or more computers and may involve the use of one or more communications networks. The present invention is not limited as to the type of computer on which it runs, and not limited as to the type of network used. The present invention is not limited as to the type of medium or format used for output. Means for providing graphical output may include sketching diagrams by hand on paper, printing images or numbers on paper, displaying images or numbers on a screen, or some combination of these, for example. A model of a solution might be provided on paper, and later the model could be the basis for a design implemented via computer, for example.

The following are definitions of terms used in the description of the present invention and in the claims:

“About,” with respect to numbers, includes variation due to measurement method, human error, statistical variance, rounding principles, and significant digits.

“Application” means any specific use for computer technology, or any software that allows a specific use for computer technology.

“Availability” means ability to be accessed or used.

“Business process” means any process involving use of a computer by any enterprise, group, or organization; the process may involve providing goods or services of any kind.

“Client-server application” means any application involving a client that utilizes a service, and a server that provides a service. Examples of such a service include but are not limited to: information services, transactional services, access to databases, and access to audio or video content.

“Comparing” means bringing together for the purpose of finding any likeness or difference, including a qualitative or quantitative likeness or difference. “Comparing” may involve answering questions including but not limited to: “Is a measured response time greater than a threshold response time?” Or “Is a response time measured by a remote probe significantly greater than a response time measured by a local probe?”

“Component” means any element or part, and may include elements consisting of hardware or software or both.

“Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory.

“Mapping” means associating, matching or correlating.

“Measuring” means evaluating or quantifying.

“Output” or “Outputting” means producing, transmitting, or turning out in some manner, including but not limited to printing on paper, or displaying on a screen, writing to a disk, or using an audio device.

“Performance” means execution or doing; for example, “performance” may refer to any aspect of an application's operation, including availability, response time, time to complete batch processing or other aspects.

“Probe” means any computer used in evaluating, investigating, or quantifying the functioning of a component or the performance of an application; for example a “probe” may be a personal computer executing a script, acting as a client, and requesting services from a server.

“Production environment” means any set of actual working conditions, where daily work or transactions take place.

“Response time” means elapsed time in responding to a request or signal.

“Script” means any program used in evaluating, investigating, or quantifying performance; for example a script may cause a computer to send requests or signals according to a transaction scenario. A script may be written in a scripting language such as Perl or some other programming language.

“Service level agreement” (or “SLA”) means any oral or written agreement between provider and user. For example, “service level agreement” includes but is not limited to an agreement between vendor and customer, and an agreement between an information technology department and an end user. For example, a “service level agreement” might involve one or more client—server applications, and might include specifications regarding availability, response times or problem—solving.

“Statistic” means any numerical measure calculated from a sample.

“Storing” data or information, using a computer, means placing the data or information, for any length of time, in any kind of computer memory, such as floppy disks, hard disks, Random Access Memory (RAM), Read Only Memory (ROM), CD-ROM, flash ROM, non-volatile ROM, and non-volatile memory.

“Threshold value” means any value used as a borderline, standard, or target; for example, a “threshold value” may be derived from customer requirements, corporate objectives, a service level agreement, industry norms, or other sources.

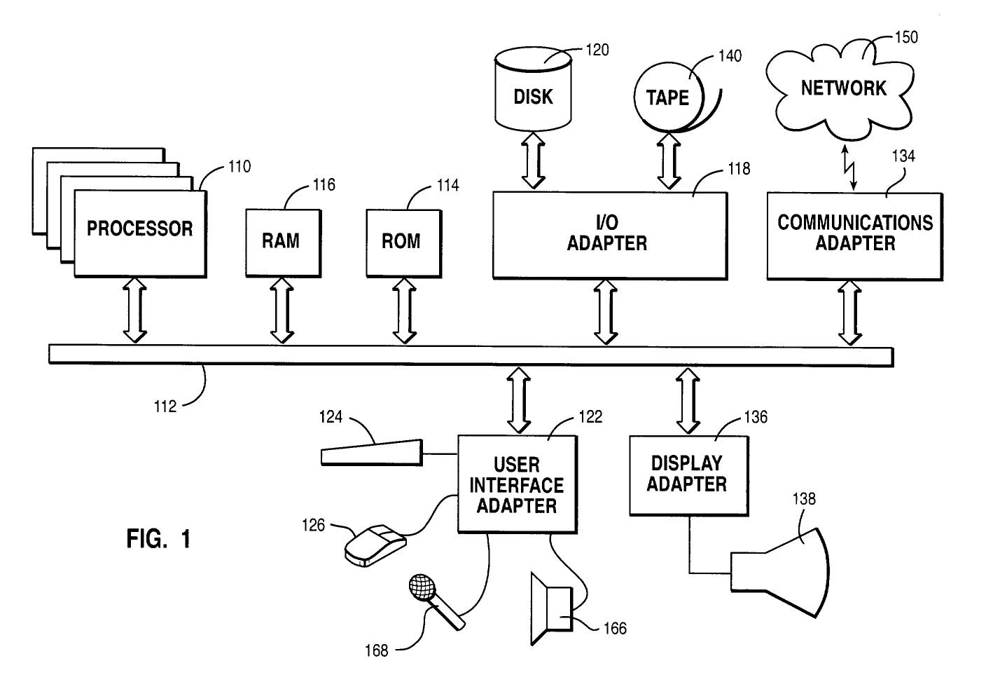

FIG. 1 illustrates a simplified example of an information handling system that may be used to practice the present invention. The invention may be implemented on a variety of hardware platforms, including embedded systems, personal computers, workstations, servers, and mainframes. The computer system of FIG. 1 has at least one processor 110. Processor 110 is interconnected via system bus 112 to random access memory (RAM) 116, read only memory (ROM) 114, and input/output (I/O) adapter 118 for connecting peripheral devices such as disk unit 120 and tape drive 140 to bus 112. The system has user interface adapter 122 for connecting keyboard 124, mouse 126, or other user interface devices such as audio output device 166 and audio input device 168 to bus 112. The system has communication adapter 134 for connecting the information handling system to a communications network 150, and display adapter 136 for connecting bus 112 to display device 138. Communication adapter 134 may link the system depicted in FIG. 1 with hundreds or even thousands of similar systems, or other devices, such as remote printers, remote servers, or remote storage units. The system depicted in FIG. 1 may be linked to both local area networks (sometimes referred to as intranets) and wide area networks, such as the Internet.

While the computer system described in FIG. 1 is capable of executing the processes described herein, this computer system is simply one example of a computer system. Those skilled in the art will appreciate that many other computer system designs are capable of performing the processes described herein.

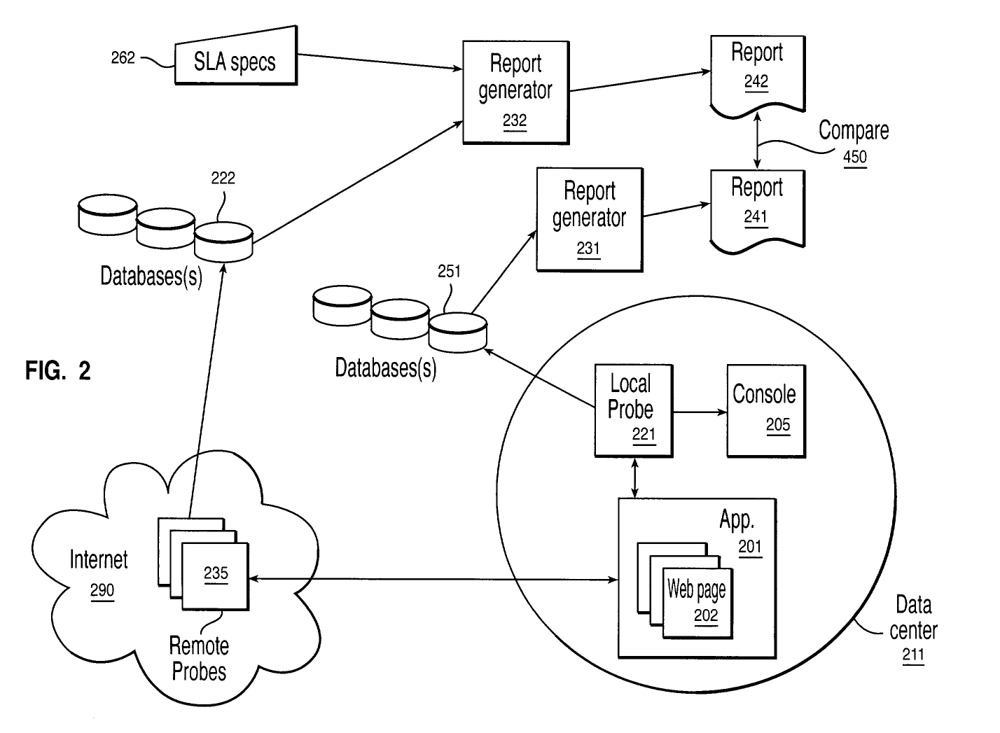

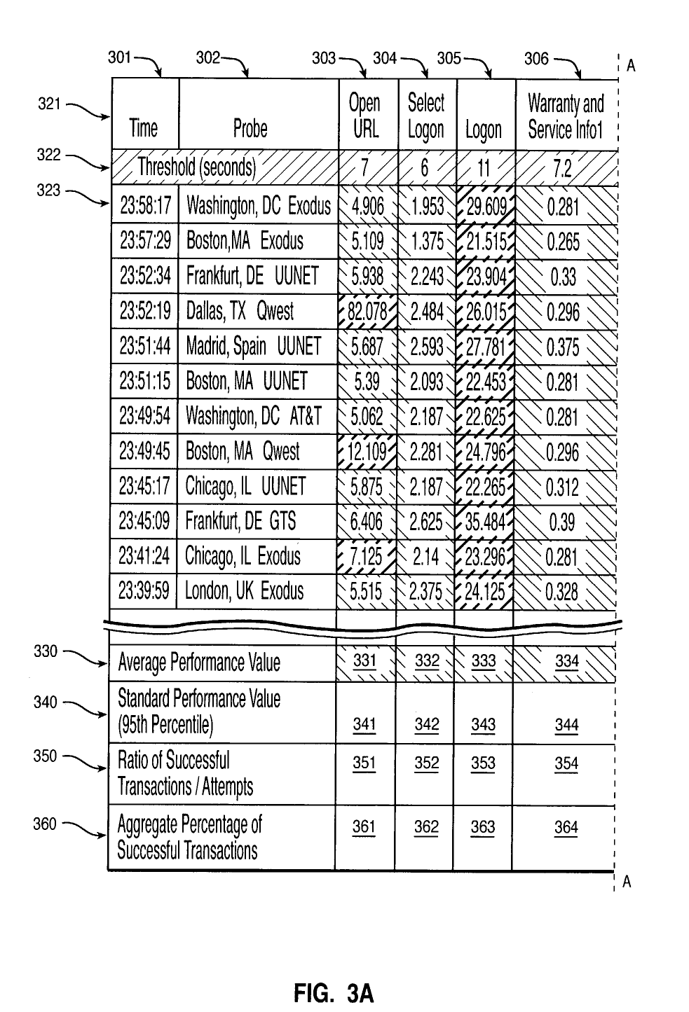

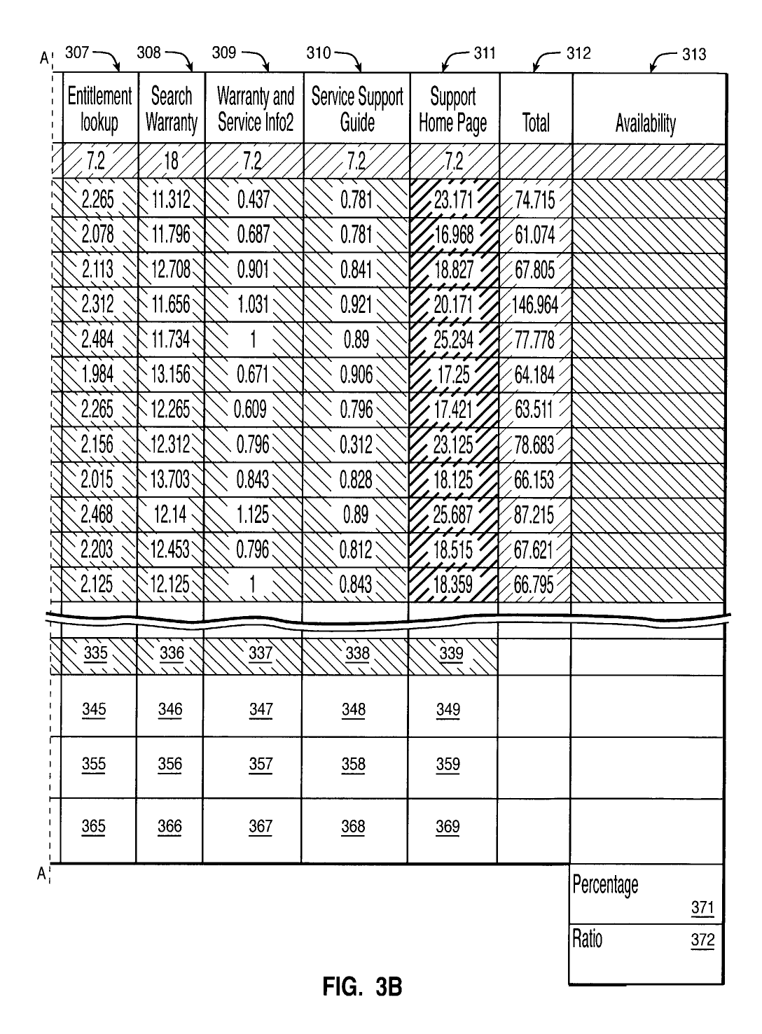

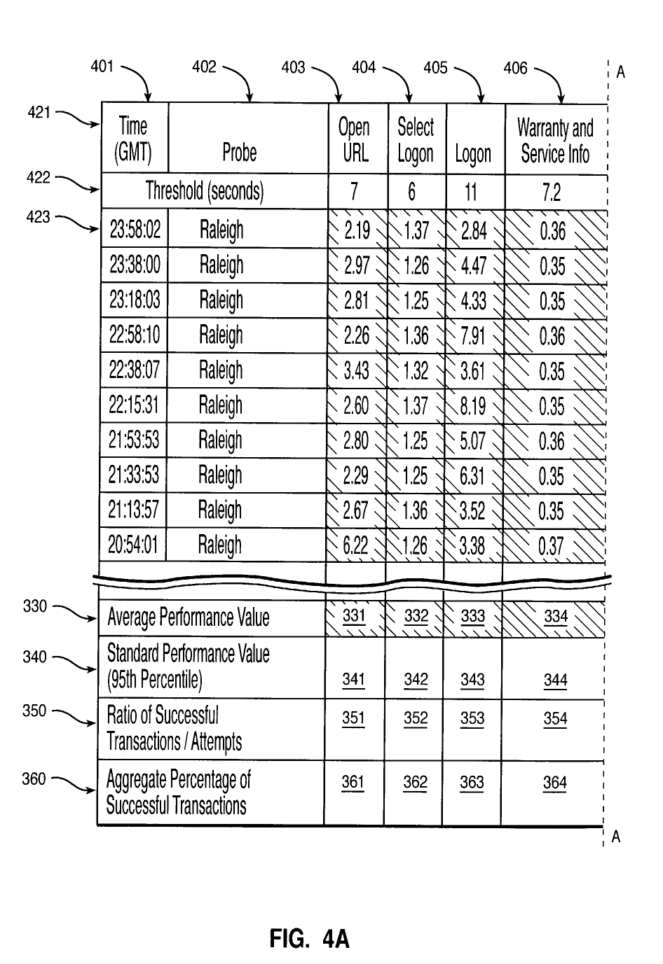

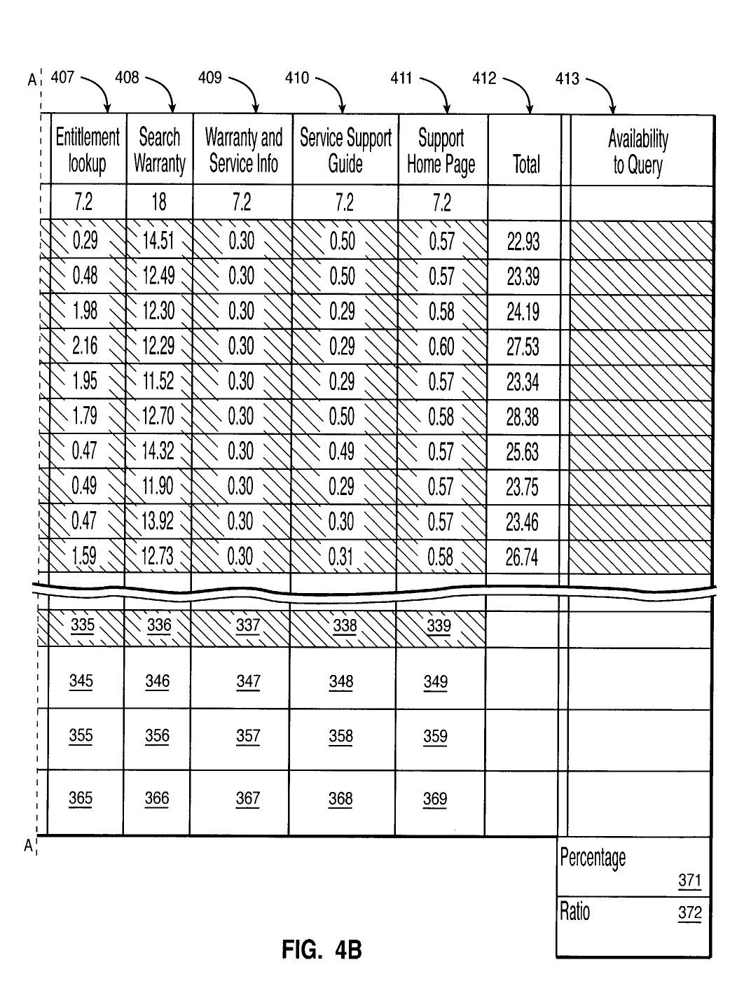

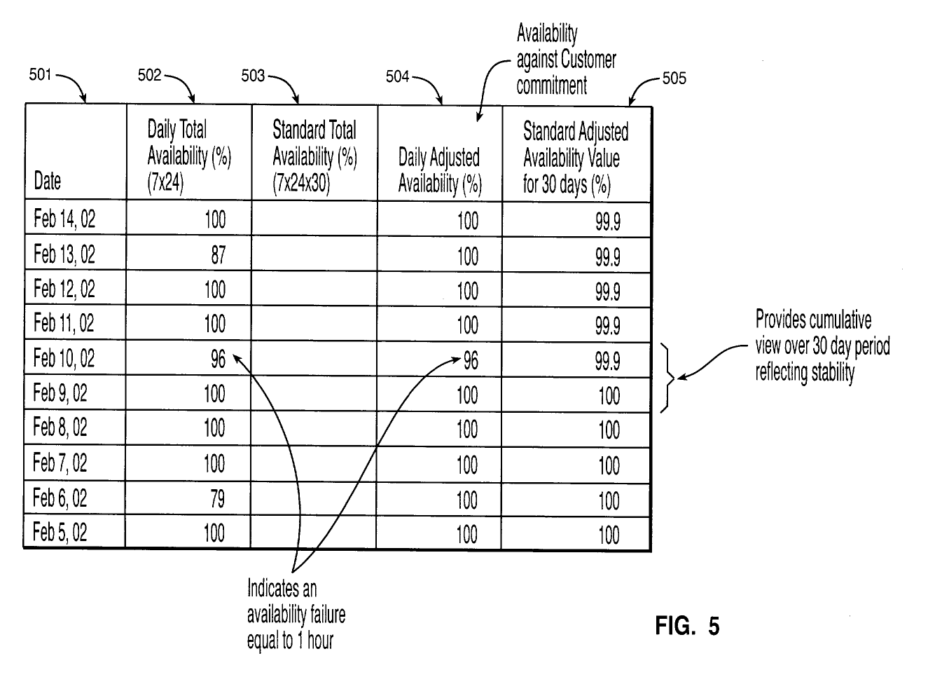

FIG. 2 is a block diagram illustrating one example of how the present invention may be implemented for communicating measurements for one or more applications. To begin with an overview, this example comprises collecting data from a production environment (data center 211), utilizing two or more probes, shown at 221 and 235. These probes and their software are means for measuring one or more applicabon's performance (application 201, with web pages at 202, symbolize one or more application). This example comprises performing calculations, regarding availability or response time or both, with at least part of the data. FIG. 2 shows means for mapping data or statistics or both to threshold values: Remote probes at 235 send to a database 222 the data produced by the measuring process. Report generator 232 and its software use specifications of threshold values (symbolized by “SLA specs” at 262) and create near-real-time reports (symbolized by report 242) as a way of mapping data or statistics or both to threshold values. Threshold values may be derived from a service level agreement (symbolized by “SLA specs” at 262) or from customer requirements, corporate objectives, industry norms, or other sources. Please see FIGS. 3A, 3B, and 5 as examples of reports symbolized by report 242. Please see FIGS. 4A and 4B as examples of reports symbolized by report 241. Reports 241 and 242 are ways of outputting data or statistics or both, and ways of mapping data or statistics or both to threshold values.

In other words, probes shown at 221 and 235, report generators shown at 231 and 232, and communication links among them (symbolized by arrows) may comprise means for receiving data from a plurality of probes; means for calculating statistics based on the data; and means for mapping the statistics to at least one threshold value. Report generators at 231 and 232, and reports 241 and 242, may comprise means for outputting a representation of the mapping. Note that in an alternative example, report generator 232 might obtain data from databases at 251 and at 222, then generate reports 241 and 242.

Turning now to some details of FIG. 2, two or more applications may be compared (application 201, with web pages at 202, symbolize one or more application). The applications being compared are not necessarily hosted at the same data center 211; FIG. 2 shows a simplified example. To give some non-limiting examples from commercial web sites, the applications may comprise: an application that creates customers' orders; an application utilized in fulfilling customers' orders; an application that responds to customers' inquiries; and an application that supports real-time transactions. For example, comparing applications may involve comparing answers to questions such as: What proportion of the time is an application available to its users? How stable is this availability figure over a period of weeks or months? How much time does it take to complete a common transaction step (e.g. a log—on step)?

The example in FIG. 2 may involve probing (arrows connecting remote probes at 235 with application 201 and connecting local probe 221 with application 201) transaction steps in a business process, and mapping each of the transaction steps to a performance target. For example, response times are measured on a transaction level. These transaction steps could be any steps involved in using an application. Some examples are steps involved in using a web site, a web application, web services, database management software, a customer relationship management system, an enterprise resource planning system, or an opportunity—management business process. For example, each transaction step in a business process is identified and documented. One good way of documenting transaction steps is as follows. Transaction steps may be displayed in a table containing the transaction step number, step name, and a description of what action the end user takes to execute the step. For example, a row in a table may read as follows. Step number: “NAQS2.” Step name: “Log on.” Description: “Enter Login ID/Password. Click on Logon button.”

Continuing with some details of FIG. 2, the same script is deployed on the local and remote probes shown at 221 and 235, to measure the performance of the same application at 201. Different scripts are deployed to measure the performance of different applications at 201. (Two versions of a script could be considered to be the same script, if they differed slightly in software settings for example.) The local probe 221 provides information that excludes the Internet, while the remote probes 235 provide information that includes the Internet (shown at 290). Thus, the information could be compared to determine whether performance or availability problems were a function of application 201 itself (infrastructure—specific or application—specific), or a function of the Internet 290. Probes measure response time for requests. The double-headed arrow connecting remote probes at 235 with application 201 symbolizes requests and responses, and so does the double-headed arrow connecting local probe 221 with application 201.

Turning now to some details of receiving data from a plurality of probes, Component Probes measure availability, utilization and performance of infrastructure components, including servers, LAN, and services. Local component probes (LCP's) may be deployed locally in hosting sites, service delivery centers or data centers (e.g. at 211). Network Probes measure network infrastructure response time and availability. Remote Network Probes (RNP's) may be deployed in a local hosting site or data center (e.g. at 211) if measuring the intranet or at Internet Service Provider (ISP) sites if measuring the Internet.

Application Probes measure availability and performance of applications and business processes.

Local Application Probe (LAP): Application probes deployed in a local hosting site or data center (e.g. at 211) are termed Local Application Probes.

Remote Application Probe (RAP): An application probe deployed from a remote location is termed a Remote Application Probe.

The concept of “probe” is a logical one. Thus for example, implementing a local application probe could actually consist of implementing multiple physical probes.

Providing a script for a probe would comprise defining a set of transactions that are frequently performed by end users. Employing a plurality of probes would comprise placing at least one remote probe (shown at 235 in FIG. 2) at each location having a relatively large population of end users. Note that the Remote Application Probe transactions and Local Application Probe transactions should be the same transactions. The example measures all the transactions locally (shown at 221), so that the local application response time can be compared to the remote application response time. (The double-headed arrow at 450 symbolizes comparison.) This can provide insight regarding application performance issues. End-to-end measurement of an organization's internal applications for internal customers may involve a RAP on an intranet, for example, whereas end-to-end measurement of an organization's external applications for customers, business partners, suppliers, etc. may involve a RAP on the Internet (shown at 235). The example in FIG. 2 involves defining a representative transaction set, and deploying remote application probes (shown at 235) at relevant end-user locations.

This example in FIG. 2 is easily generalized to other environments besides web—based applications. The one or more application at 201 may be any client-server application, for example. Some examples are a web site, a web application, database management software, a customer relationship management system, an enterprise resource planning system, or an opportunity—management business process where a client directly connects to a server.

FIG. 3A and FIG. 3B illustrate an example of a report with data from remote probes, and statistics, resulting from probing a web site. Similar reports could be produced in connection with probing other kinds of web sites, or probing other kinds of applications. A report like this may be produced each day.

The broken line AA shows where the report is divided into two sheets. The wavy lines just above row 330 show where rows are omitted from this example, to make the length manageable. Columns 303-312 display response time data in seconds. Each of the columns 303-311 represent a transaction step. Column 312 represents the total of the response times for all the transaction steps. A description of the transaction step is shown in the column heading in row 321. Column 313 displays availability information, using a color code. In this example, a special color is shown by darker shading, seen in the cells of column 311. For example, the cell in column 313 is green if all the transaction steps are completed; otherwise the cell is red, representing a failed attempt to execute all the transaction steps. Thus column 313 may provide a measure of end-to-end availability from a probe location, since a business process could cross multiple applications deployed in multiple hosting centers. Column 302 shows probe location and Internet service provider information. Column 301 shows time of script execution. Each row from row 323 downward to row 330 represents one iteration of the script; each of these rows represents how one end user's execution of a business process would be handled by the web site.

Turning to some details of FIG. 3A and FIG. 3B, this example involves comparing data and statistics with threshold values. To report the results of this comparing, color is used in this example. Row 322 shows threshold values. In each column, response times for a transaction step are compared with a corresponding threshold value. For example, column 303 is for the “open URL” step. For that step, column 303 reports results of each script execution by a plurality of probes. This example involves outputting in a special mode any measured response time value that is greater than the corresponding threshold value. Outputting in a special mode may mean outputting in a special color, for example, or outputting with some other visual cue such as highlighting or a special symbol (e.g. the special color may be red).

Continuing with details of FIG. 3A and FIG. 3B, this example involves calculating and outputting statistics. In each of cells 331-369, a statistic is aligned with a corresponding threshold value in row 322. Cells 331-369 reflect calculating, mapping, and outputting, for statistics. In row 330, cells 331-339 display average performance values. This statistic involves utilizing successful executions of a transaction step, utilizing response times for the transaction step, calculating an average performance value, and outputting the average performance value (in row 330). Failed executions and executions that timed out are not included in calculating an average performance value, but are represented in ratios in row 350, and affect availability results, in this example. This example also involves comparing the average performance value with a corresponding threshold value (in row 322); and reporting the results (in row 330) of the comparison. This example also involves outputting in a special mode (in row 330) the average performance value when it is greater than the corresponding threshold value (in row 322). Outputting in a special mode may mean outputting in a special color (e.g. the special color may be red) or outputting with some other visual cue as described above. For example, depending on the values in the omitted rows, the average performance value in cell 333 could be displayed in red when it is greater than the corresponding threshold value (in row 322).

Continuing with details of FIG. 3A and FIG. 3B, this example involves calculating a standard performance value, and outputting (row 340, cells 341-349) the standard performance value. This example involves utilizing successful executions of a transaction step, and utilizing the 95th percentile of response times for the transaction step. In each of cells 341-349, a standard performance value is aligned with a corresponding threshold value in row 322. Row 340, cells 341-349, reflect calculating, mapping, and outputting, for a standard performance value.

Continuing with details of FIG. 3A and FIG. 3B, this example involves calculating a transaction step's availability proportion, and outputting the transaction step's availability proportion (in rows 350 and 360). The proportion is expressed as a ratio of successful executions to attempts, in row 350, cells 351-359. The proportion is expressed as a percentage of successful executions in row 360, cells 361-369 (the transaction step's “aggregate” percentage).

Continuing with details of FIG. 3B, this example involves calculating a total availability proportion, and outputting the total availability proportion (at cells 371 and 372). The proportion is expressed as a percentage of successful executions in cell 371. The proportion is expressed as a ratio of successful executions to attempts, in cell 372. This proportion represents successful execution of a business process that includes multiple transaction steps.

FIG. 4A and FIG. 4B illustrate an example of a report with data from a local probe, and statistics. This example may be considered by itself as an example involving one probe, or may be considered together with the example shown in FIG. 3A and FIG. 3B.

Generally, the features are similar to those described above regarding FIG. 3A and FIG. 3B, so descriptions of those features will not be repeated at length here. A report may contain error messages (not shown in this example). The reporting may comprise: reporting a subset (report shown in FIG. 4A and FIG. 4B) of the data and statistics that originated from a local probe; reporting a subset (report shown in FIG. 3A and FIG. 3B) of the data and statistics that originated from remote probes; and employing a similar reporting format for both subsets. Thus comparison of data and statistics from a local probe and from remote probes is facilitated. In a like way, employing a similar reporting format for data and statistics from two or more applications would facilitate comparison of the applications. Regarding threshold values, note that an alternative example might involve threshold values that differed between the local and remote reports. Threshold values may need to be adjusted to account for Internet—related delays.

Turning now to particular features shown in FIG. 4A and FIG. 4B, broken line AA shows where the report is divided into two sheets. The wavy lines just above row 330 show where rows are omitted from this example, to make the length manageable. Columns 403-412 display response time data in seconds. Each of the columns 403-411 represent a transaction step. Column 412 represents the total of the response times for all the transaction steps. A description of the transaction step is shown in the column heading in row 421. Column 413 displays availability information. Column 402 shows probe location. Column 401 shows time of script execution. Each row from row 423 downward to row 330 represents one iteration of the script. Row 422 shows threshold values. In each column, response times for a transaction step are compared with a corresponding threshold value.

In each of cells 331-369, a statistic is aligned with a corresponding threshold value in row 422. Cells 331-369 reflect calculating, mapping, and outputting, for statistics. In row 330, cells 331-339 display average performance values. In row 340, cells 341-349 display standard performance values. A transaction step's availability proportion is expressed as a ratio of successful executions to attempts, in row 350, cells 351-359. The proportion is expressed as a percentage of successful executions in row 360, cells 361-369. Finally, this example in FIG. 4B involves calculating and outputting a total availability proportion. The proportion is expressed as a percentage of successful executions in cell 371, and as a ratio of successful executions to attempts, in cell 372.

FIG. 5 illustrates an example of a report that gives an availability summary. This is one way to provide consistent availability reporting over an extended period of time (e.g. a 30-day period). Column 501 displays dates. Column 502 displays a daily total availability, such as a total availability proportion available from FIG. 3B at cell 371, for example. Here, daily total availability is calculated for a 24-hour period, and represented as a percentage.

Column 503 displays a standard total availability, based on Column 502's daily total availability (e.g. a 30-day rolling average). Here, standard total availability is calculated from the last 30-day period (rolling average, 24×30) and is represented as a percentage.

Column 504 displays a daily adjusted availability. It is calculated based on some threshold, such as a commitment to a customer to make an application available during defined business hours, for example. In other words, column 504's values are adjusted to measure availability against a commitment to a customer or a service level agreement, for example. Column 504 is one way of mapping measures to a threshold value. Column 504 reflects calculating, mapping, and outputting, for an adjusted availability value. In this example, daily adjusted availability is calculated from the daily filtered measurements captured during defined business hours, and is represented as a percentage. This value is used for assessing compliance with an availability threshold.

Column 505 displays a standard adjusted availability, based on Column 504's daily adjusted availability (e.g. a 30-day rolling average). In this example, standard adjusted availability is calculated from the daily filtered measurements captured during defined business hours, across the last 30-day period (rolling average, defined business hours×30). Column 505 may provide a cumulative view over a 30-day period, reflecting the degree of stability for an application or a business process. The change from 100% on Feb. 9 to 99.9% on February 10, in column 505, shows the effect of the 96% value on Feb. 10, in columns 502 and 504. The 96% value on February. 10, in columns 502 and 504, indicates an availability failure equal to 1 hour.

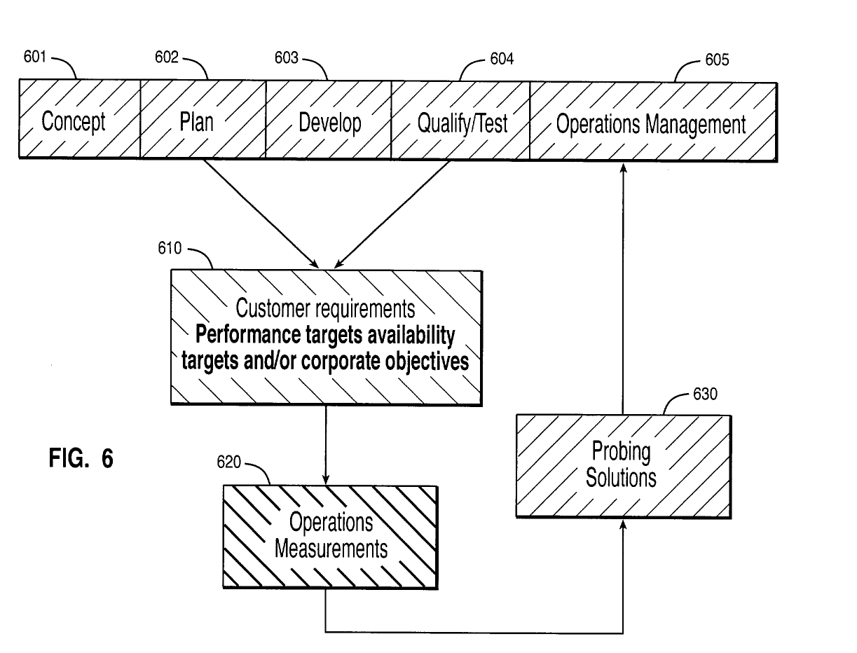

FIG. 6 is a block diagram illustrating one example of how measurements may be utilized in the development, deployment and management of an application. Beginning with an overview, blocks 601, 602, 603, and 604 symbolize an example of a typical development process for an application (a web—based business application for example). This example begins with a concept phase at block 601, followed by a planning phase, block 602, and a development phase at block 603. Following a qualifying or testing phase at block 604, the application is deployed and the operations management phase is entered, at block 605.

Blocks 602 and 610 are connected by an arrow, symbolizing that in the planning phase, customer requirements at 610 (e.g. targets for performance or availability) are understood and documented. Thus block 610 comprises setting threshold values, and documenting the threshold values. Work proceeds with developing the application at block 603. The documented threshold values may provide guidance and promote good design decisions in developing the application. Once developed, an application is evaluated against the threshold values. Thus the qualifying or testing phase at block 604, and block 610, are connected by an arrow, symbolizing measuring the application's performance against the threshold values at 610. This may lead to identifying an opportunity to improve the performance of an application, in the qualifying or testing phase at block 604.

As an application is deployed into a production environment, parameters are established to promote consistent measurement by probes. Thus the example in FIG. 6 further comprises: deploying the application (transition from qualifying or testing phase at block 604 to operations at block 605), providing an operations measurement policy for the application (at block 620, specifying how measures are calculated and communicated for example), and providing probing solutions for the application (at block 630). Probing solutions at block 630 are described above in connection with probes shown at 221 and 235 in FIG. 2. Blocks 620, 630, and 605 are connected by arrows, symbolizing utilization of operations measurements at 620, and utilization of probing solutions at 630, in managing the operation of an application at 605. For example, the operations management phase at 605 may involve utilizing the output from operations measurements at 620 and probing solutions at 630. A representation of a mapping of statistics to threshold values may be utilized in managing the operation of an application, identifying an opportunity to improve the performance of an application, and taking corrective action.

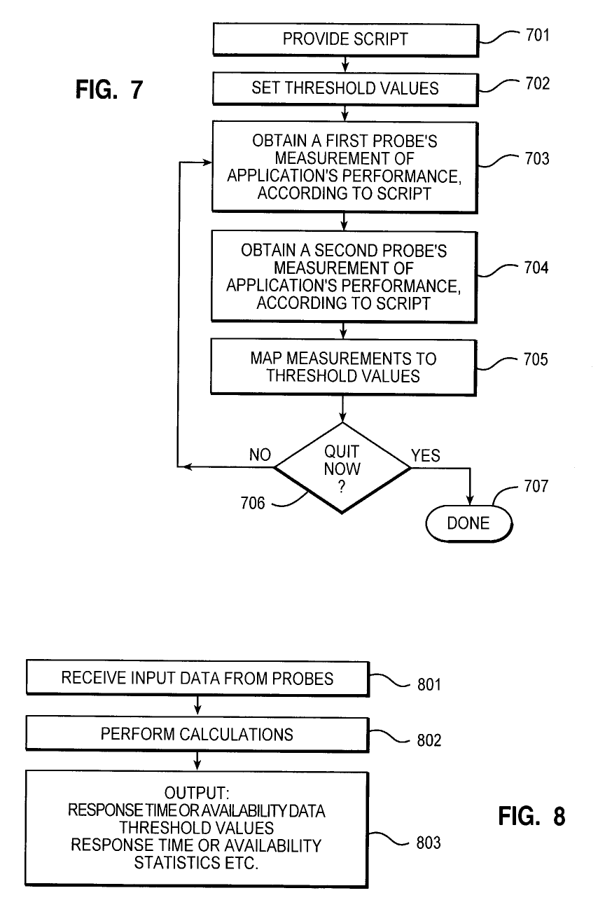

In the example in FIG. 6, documentation of how to measure performance in a production environment is integrated with a development process, along with communication of performance information, which is further described below in connection with FIGS. 7 and 8.

FIG. 7 is a flow chart with a loop, illustrating an example of communicating measurements, according to the teachings of the present invention. For example, communicating measurements may be utilized for two or more applications, whereby those applications may be compared; or communicating measurements may be integrated with a software development process as illustrated in FIG. 6. The example in FIG. 7 begins at block 701, providing a script. Providing a script may comprise defining a set of transactions that are frequently performed by end users. Providing a script may involve decomposing a business process. The measured aspects of a business process may for example: represent the most common tasks performed by the end users, exercise major components of the applications, cover multiple hosting sites, cross multiple applications, or involve specific infrastructure components that should be monitored on a component level.

Using a script developed at block 701, local and remote application probes may measure the end-to-end user experience for repeatable transactions, either simple or complex. End-to-end measurements focus on measuring the business process (as defined by a repeatable sequence of events) from the end user's perspective. End-to-end measurements tend to cross multiple applications, services, and infrastructure. Examples would include: create an order, query an order, etc. Ways to implement a script that runs on a probe are well-known (see details of example implementations below). Vendors provide various services that involve a script that runs on a probe.

Block 702 represents setting threshold values. Threshold values may be derived from a service level agreement [SLA], or from sources shown in FIG. 6, block 610, such as customer requirements, targets for performance or availability, or corporate objectives for example.

Operations at 703 and 704 were covered in the description given above for FIG. 2. These operations are: block 703, obtaining a first probe's measurement of an application's performance, according to the script; and block 704, obtaining a second probe's measurement of the application's performance, according to the script. In other words, blocks 703 and 704 may involve receiving data for a plurality of transaction steps, from a plurality of probes.

The example in FIG. 7 continues at block 705, mapping measurements to threshold values. Operations at block 705 may comprise calculating statistics based on the data, mapping the statistics to at least one threshold value, and outputting a representation of the mapping. Reports provide a way of mapping data or statistics to threshold values. For example, see FIGS. 3A, 3B, 4A, 4B, and 5.

Operations at 703, 704, and 705 may be performed repeatedly (shown by the “No” branch being taken at decision 706 and the path looping back to block 703) until the process is terminated (shown by the “Yes” branch being taken at decision 706, and the process terminating at block 707). Operations in FIG. 7 may be performed for a plurality of applications, whereby the applications may be compared.

FIG. 8 is a flow chart illustrating another example of calculating and communicating measurements, according to the teachings of the present invention. The example in FIG. 8 begins at block 801, receiving input from probes. Operations at block 801 may comprise collecting data from a production environment, utilizing a plurality of probes. The example continues at block 802, performing calculations. This may involve performing calculations, regarding availability or response time or both, with at least part of the data. Next, operations at block 803 may comprise outputting response time or availability data, outputting threshold values, and outputting statistics resulting from the calculations, such as response time or availability statistics.

Operations at blocks 801-803 may be performed repeatedly, as with FIG. 7.

Operations at blocks 801-803 may be performed for a plurality of applications, whereby the applications may be compared.

Regarding FIGS. 7 and 8, the order of the operations in the processes described above may be varied. For example, in FIG. 7, it is within the practice of the invention for block 702, setting threshold values, to occur before, or simultaneously with, block 701, providing a script. Those skilled in the art will recognize that blocks in FIGS. 7 and 8, described above, could be arranged in a somewhat different order, but still describe the invention. Blocks could be added to the above-mentioned diagrams to describe details, or optional features; some blocks could be subtracted to show a simplified example.

This final section of the detailed description provides details of example implementations, mainly referring back to FIG. 2. In one example, remote probes shown in FIG. 2 at 235 were implemented by contracting for probing services available from Mercury Interactive Corporation, but services from another vendor could be used, or remote probes could be implemented by other means (e.g. directly placing probes at various Internet Service Providers (ISP's)). A remote probe 235 may be used to probe one specific site per probe; a probe also has the capability of probing multiple sites. There could be multiple scripts per site. Remote probes 235 were located at various ISP's in parts of the world that the web site (symbolized by application 201) supported. In one example, a remote probe 235 executed the script every 60 minutes. Intervals of other lengths also could be used. If multiple remote probes at 235 are used, probe execution times may be staggered over the hour to ensure that the performance of the web site is being measured throughout the hour. Remote probes at 235 sent to a database 222 the data produced by the measuring process. In one example, database 222 was implemented by using Mercury Interactive's database, but other database management software could be used, such as software products sold under the trademarks DB2 (by IBM), ORACLE, INFORMIX, SYBASE, MYSQL, Microsoft Corporation's SQL SERVER, or similar software. In one example, report generator 232 was implemented by using Mercury Interactive's software and web site, but another automated reporting tool could be used, such as the one described below for local probe data (shown as report generator 231). IBM's arrangement with Mercury Interactive included the following: Mercury Interactive's software at 232 used IBM's specifications (symbolized by “SLA specs” at 262) and created near-real-time reports (symbolized by report 242) in a format required by IBM; IBM's specifications and format were protected by a confidential disclosure agreement; the reports at 242 were supplied in a secure manner via Mercury Interactive's web site at 232; access to the reports was restricted to IBM entities (the web site owner, the hosting center, and IBM's world wide command center).

Continuing with some details of example implementations, we located application probes locally at hosting sites (e.g. local probe shown at 221, within data center 211) and remotely at relevant end-user sites (remote probes at 235). This not only exercised the application code and application hosting site infrastructure, but also probed the ability of the application and network to deliver data from the application hosting site to the remote end-user sites. While we measured the user availability and performance from a customer perspective (remote probes at 235), we also measured the availability and performance of the application at the location where it was deployed (local probe shown at 221, within data center 211). This provided baseline performance measurement data, that could be used for analyzing the performance measurements from the remote probes (at 235).

In one example, Local probe 221 was implemented with a personal computer, utilizing IBM's Enterprise Probe Platform technology, but other kinds of hardware and software could be used. A local probe 221 was placed on the IBM network just outside the firewall at the center where the web site was hosted. A local probe 221 was used to probe one specific site per probe. There could be multiple scripts per site. A local probe 221 executed the script every 20 minutes, in one example. Intervals of other lengths also could be used. In one example, local application probe 221 automatically sent events to the management console 205 used by the operations department.

In one example, Local probe 221 sent to a database 251 the data produced by the measuring process. Database 251 was implemented by using a software product sold under the trademark DB2 (by IBM), but other database management software could be used, such as software products sold under the trademarks ORACLE, INFORMIX, SYBASE, MYSQL, Microsoft Corporation's SQL SERVER, or similar software. For local probe data, an automated reporting tool (shown as report generator 231) ran continuously at set intervals, obtained data from database 251, and sent reports 241 via email to these IBM entities: the web site owner, the hosting center, and IBM's world wide command center. Reports 241 also could be posted on a web site at the set intervals. Report generator 231 was implemented by using the Perl scripting language and the AIX operating system. However, some other programming language could be used, and another operating system could be used, such as LINUX, or another form of UNIX, or some version of Microsoft Corporation's WINDOWS, or some other operating system.

Continuing with details of example implementations, a standard policy for operations measurements (appropriate for measuring the performance of two or more applications) was developed. This measurement policy facilitated consistent assessment of IBM's portfolio of e-business initiatives. In a similar way, a measurement policy could be developed for other applications, utilized by some other organization, according to the teachings of the present invention. The above-mentioned measurement policy comprised measuring the performance of an application continuously, 7 days per week, 24 hours per day, including an application's scheduled and unscheduled down time. The above-mentioned measurement policy comprised measuring the performance of an application from probe locations (symbolized by probes at 235 in FIG. 2) representative of the customer base of the application. The above-mentioned measurement policy comprised utilizing a sampling interval of about 15 minutes (sampling 4 times per hour, for example, with an interval of about 15 minutes between one sample and the next). Preferably, a sampling interval of about 10 minutes to about 15 minutes may be used.

For measuring availability, the above-mentioned measurement policy comprised measuring availability of an application from at least two different probe locations. A preferred approach utilized at least two remote probes (symbolized by probes shown at 235), and utilized probe locations that were remote from an application's front end. A local probe and a remote probe (symbolized by probes shown at 221 and 235 in FIG. 2) may be used as an alternative. The above-mentioned measurement policy comprised rating an application or a business process “available,” only if each of the transaction steps was successful within a timeout period. In one example, the policy required that each of the transaction steps be successful within approximately 45 seconds of the request, as a prerequisite to rating a business process “available.” Transactions that exceeded the 45-second threshold were considered failed transactions, and the business process was considered unavailable.

To conclude the implementation details, FIGS. 3A, 3B, 4A and 4B illustrate examples of reports that were generated with data produced by probing a web site, that served an after-sales support function. The probes used a script representing a typical inquiry about a product warranty. Also note that these diagrams illustrate examples where hypertext markup language (HTML) was used to create the reports, but another language such as extensible markup language (XML) could be used.

In conclusion, we have shown examples of solutions to problems that are related to inconsistent measurement, and in particular, solutions for calculating and communicating measurements.

One of the possible implementations of the invention is an application, namely a set of instructions (program code) executed by a processor of a computer from a computer-usable medium such as a memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the method.

While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements.

However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

We claim:

1. A method for calculating and communicating measurements, said method comprising:
(a) collecting data from a production environment, utilizing a plurality of probes;
(b) performing calculations, regarding availability or response time or both, with at least part of said data;
(c) outputting statistics, resulting from said calculations; and
(d) performing (a)-(c) above for a plurality of applications;
whereby said plurality of applications may be compared.

2. The method of claim 1, further comprising:
outputting a representation of compliance or non-compliance with at least one threshold value.

3. The method of claim 1, wherein said outputting further comprises outputting statistics for a plurality of transaction steps per application.

4. The method of claim 1, wherein:
said performing calculations further comprises calculating a standard performance value; and
said outputting further comprises outputting said standard performance value.

5. The method of claim 4, wherein said calculating a standard performance value further comprises:
utilizing successful executions of a transaction step; and
utilizing the 95th percentile of response times for said transaction step.

6. The method of claim 1, wherein:
said performing calculations further comprises calculating a transaction step's availability proportion; and
said outputting further comprises outputting said transaction step's availability proportion.

7. The method of claim 1, wherein:
said performing calculations further comprises calculating a total availability proportion; and
said outputting further comprises outputting said total availability proportion.

8. The method of claim 1, wherein said performing calculations further comprises performing (a)-(c) below for a plurality of transaction steps per application:
(a) utilizing successful executions of a transaction step;
(b) utilizing response times for said transaction step; and
(c) calculating an average performance value; and
wherein said outputting further comprises outputting said average performance value.

9. The method of claim 8, further comprising:
comparing said average performance value with a corresponding threshold value; and
wherein said outputting further comprises reporting results of said comparing.

10. The method of claim 9, wherein said outputting further comprises outputting in a special mode said average performance value when it is greater than said corresponding threshold value.

11. The method of claim 10, wherein said outputting in a special mode further comprises outputting in a special color.

12. The method of claim 11, wherein said special color is red.

13. The method of claim 1, wherein:
said performing calculations further comprises calculating an adjusted availability value, associated with at least one threshold value; and
said outputting further comprises outputting said adjusted availability value.

14. A method for calculating and communicating measurements, said method comprising:
receiving data for a plurality of transaction steps, from a plurality of probes;
calculating statistics based on said data;
mapping said statistics to at least one threshold value; and
outputting a representation of said mapping.

15. The method of claim 14, further comprising:
carrying out said receiving data, said calculating, said mapping, and said outputting for a plurality of applications;
whereby said plurality of applications may be compared.

16. The method of claim 14, further comprising:
utilizing said representation in managing the operation of an application.

17. The method of claim 14, further comprising:
carrying out said calculating, said mapping, and said outputting, for a standard performance value.

18. The method of claim 14, further comprising:
carrying out said calculating, said mapping, and said outputting, for an adjusted availability value.

19. The method of claim 14, further comprising:
planning an application;
setting said at least one threshold value;
documenting said at least one threshold value; and
developing said application;
whereby said application's performance is measured against said at least one threshold value.

20. The method of claim 14, further comprising:
mapping said data to said at least one threshold value; and
outputting a representation of said mapping of said data.

21. A system for calculating and communicating measurements, said system comprising:
means for receiving data for a plurality of transaction steps, from a plurality of probes;
means for calculating statistics based on said data;
means for mapping said statistics to at least one threshold value; and
means for outputting a representation of said mapping.

22. The system of claim 21, wherein:
said means for receiving data, said means for calculating, said means for mapping, and
said means for outputting operate for a plurality of applications;
whereby said plurality of applications may be compared.

23. The system of claim 21, wherein:
said means for calculating, said means for mapping, and said means for outputting operate for a standard performance value.

24. The system of claim 21, wherein:
said means for calculating, said means for mapping, and said means for outputting operate for an adjusted availability value.

25. The system of claim 21, further comprising:
means for mapping said data to said at least one threshold value; and
means for outputting a representation of said mapping of said data.

26. A computer-usable medium having computer-executable instructions for calculating and communicating measurements, said computer-executable instructions comprising:
means for receiving data for a plurality of transaction steps, from a plurality of probes;
means for calculating statistics based on said data;
means for mapping said statistics to at least one threshold value; and
means for outputting a representation of said mapping.

27. The computer-usable medium of claim 26, wherein:
said means for receiving data, said means for calculating, said means for mapping, and said means for outputting operate for a plurality of applications;
whereby said plurality of applications may be compared.

28. The computer-usable medium of claim 26, wherein:
said means for calculating, said means for mapping, and said means for outputting operate for a standard performance value.

29. The computer-usable medium of claim 26, wherein:
said means for calculating, said means for mapping, and said means for outputting operate for an adjusted availability value.

30. The computer-usable medium of claim 26, further comprising:
means for mapping said data to said at least one threshold value; and
means for outputting a representation of said mapping of said data.
